(19) United States
(12) Patent Application Publication
(10) Pub. No.: US 2020/0309315 A1
(43) Pub. Date: Oct. 1, 2020

(54) GANTRY SYSTEM AND METHOD

(71) Applicant: SANMINA CORPORATION, San Jose, CA (US)

(72) Inventors: Robert Steven Newberry, New Hope, AL (US); David Murray, New Hope, AL (US)

(21) Appl. No.: 16/835,020

(22) Filed: Mar. 30, 2020

Related U.S. Application Data
(60) Provisional application No. 62/826,848, filed on Mar. 29, 2019.

(51) Int. Cl. F16M 13/02; F16C 19/08

(52) U.S. Cl. CPC F16M 13/02; F16C 19/08

(57) ABSTRACT

A gantry system comprises a bearing assembly including at least two rows of ball bearings, an inner race portion including an inner race and a first outer peripheral face and an outer race portion including an outer race and a second outer peripheral face. A first mounting plate is mounted to the first outer peripheral face of the inner race portion. The first mounting plate has a substantial portion that is relatively flat where it contacts the first outer peripheral face. In addition, the first mounting plate is relatively thin in comparison to the inner race portion such that the first mounting plate conforms to the surface of the inner race portion.

### CROSS REFERENCE TO RELATED APPLICATIONS

The present application claims priority under 35 U.S.C. § 119(e) to U.S. Provisional Application No. 62/826,848 entitled, “GANTRY SYSTEM AND METHOD,” filed Mar. 29, 2019, and hereby expressly incorporated by reference herein;

### FIELD

This application relates to systems and methods for load bearing and in particular, to an improved gantry system including a rotating ball bearing assembly.

### BACKGROUND

A gantry girder includes one or more girders for supporting a load that is attached to the one or more girders using ball bearings. The ball bearings rotate and allow the load to be moveable along the one or more girders.

Traditional rotating gantry designs have several sets of problems that are often universal among the existing designs in the market. Those problems include for example:
Large overhung loads that are non-uniform and require balancing;
Heat being generated into the bearings;
Inability to maintain a consistent roundness and flatness overall;
Distortion due to mounting of various apparatus;
Routine maintenance;
Proper tensioning of belt;
Drive belts being skew of bearing center line; and
Shorter life expectancy due to overall accumulations of above problems.

Gantry systems are generally included as part of image scanning systems, such as an X-ray, CAT scan or MRI imaging system. For example, the gantry system holds the radiation detectors and/or the radiation sources, e.g. x-ray, electromagnetic radiation, or magnetic field generators depending on the purpose of the device.

For example, one type of X-ray system for security imaging in airports, buildings, etc. includes a gantry system configured to rotate a single-beam X-ray tube around the object being examined to generate two dimensional (2-D) images (which may then be reconstructed into 3-D images). The fast rotation of the heavy gantry holding the X-ray tube creates significant wear and tear, resulting in high maintenance costs and frequent, unplanned downtime. The rotation also limits scanning speed and capacity and blurs the images, resulting in “image artifacts” that cause false alarms and delays, which sometimes results in highly emotional reactions. In high volume airport security screening, false alarm rates run up to 30%, necessitating additional inspections that cost over $1 billion annually according to the TSA.

As such, there is a need for an improved gantry system and method for supporting a load, especially an improved gantry for rotating a load in an imaging system.

### SUMMARY

According to a first aspect, a gantry system includes a bearing assembly having at least two rows of ball bearings. The bearing assembly includes an inner race portion that is fixed including an inner race and a first outer peripheral face, wherein the first outer peripheral face is relatively flat and an outer race portion that moves radially along an axis with the two rows of ball bearings including an outer race and a second outer peripheral face, wherein the second outer peripheral face is relatively flat. A first mounting plate is fixed and mounted to the first outer peripheral face of the inner race portion, wherein a substantial portion of the first mounting plate is relatively flat where it contacts the first outer peripheral face.

According to another aspect, a gantry system includes a bearing assembly having at least two rows of ball bearings; and an inner race portion including an inner race and a first outer peripheral face, wherein the first outer peripheral face is relatively flat; and an outer race portion including an outer race and a second outer peripheral face, wherein the second outer peripheral face is relatively flat. A first mounting plate is mounted to the first outer peripheral face of the inner race portion, wherein a substantial portion of the first mounting plate is relatively flat where it contacts the first outer peripheral face. A second mounting plate is mounted to the second outer peripheral face of the outer race portion, wherein a substantial portion of the second mounting plate is relatively flat where it contacts the second outer peripheral face.

In one or more of the above aspects, the first mounting plate is face mounted to the first outer peripheral face of the inner race portion with a plurality of bolts positioned in an approximately circular pattern around a circumference of the inner race portion.

In one or more of the above aspects, the first mounting plate has a thickness less than a thickness of the inner race portion.

In one or more of the above aspects, the second mounting plate has a thickness less than a thickness of the outer race portion.

In one or more of the above aspects, the first and second mounting plate are aluminum or an aluminum alloy.

In one or more of the above aspects, a radially mounted bracket is attached to a top of the second mounting plate, wherein the radially mounted bracket is attached to a load requiring three or more contact points for attachment.

In one or more of the above aspects, a face mounted bracket is attached to a peripheral face of the second mounting plate, wherein the face mounted bracket is attached to a load requiring three or less contact points for attachment.

In one or more of the above aspects, the gantry system further includes a tension belt and a tensioning system configured to automatically adjust a tension of the tension belt.

In one or more of the above aspects, the tensioning system includes a spring assembly configured to apply a force perpendicular to a jerk vector derived from an acceleration of the tension belt.

### BRIEF DESCRIPTION OF THE DRAWINGS

FIG. 1 illustrates a cross-section of a known bearing assembly in a current gantry system.

FIG. 2 illustrates a cross-section of an embodiment of a bearing assembly in a gantry system.

FIG. 3 illustrates a cross-section of another embodiment of the bearing assembly.

FIG. 4A illustrates a cross-section of an embodiment of a mounting system for the bearing assembly.

FIG. 4B illustrates a cross-section of another embodiment of the mounting system for the bearing assembly.

FIG. 5 illustrates a cross-section of another embodiment of the mounting system in the gantry system.

FIG. 6 illustrates a cross-section of another embodiment of the mounting system in the gantry system.

FIG. 7 illustrates a cross-section of another embodiment of the mounting system in the gantry system.

FIG. 8 illustrates a cross-section of a cross-sectional view of an embodiment of a tensioning system in the gantry system.

FIG. 9 illustrates a cross-section of another view of an embodiment of the tensioning system in the gantry system.

FIG. 10 illustrates a perspective view of an embodiment of the gantry system implemented in a computed tomography (CT) scanner.

FIG. 11 illustrates an internal view of an embodiment of the gantry system implemented in a CT scanner

### DETAILED DESCRIPTION

The word “exemplary” or “embodiment” is used herein to mean “serving as an example, instance, or illustration.” Any implementation or aspect described herein as “exemplary” or as an “embodiment” is not necessarily to be construed as preferred or advantageous over other aspects of the disclosure. Likewise, the term “aspects” does not require that all aspects of the disclosure include the discussed feature, advantage, or mode of operation.

Embodiments will now be described in detail with reference to the accompanying drawings. In the following description, numerous specific details are set forth in order to provide a thorough understanding of the aspects described herein. It will be apparent, however, to one skilled in the art, that these and other aspects may be practiced without some or all of these specific details. In addition, well known steps in a method of a process may be omitted from flow diagrams presented herein in order not to obscure the aspects of the disclosure. Similarly, well known components in a device may be omitted from figures and descriptions thereof presented herein in order not to obscure the aspects of the disclosure.

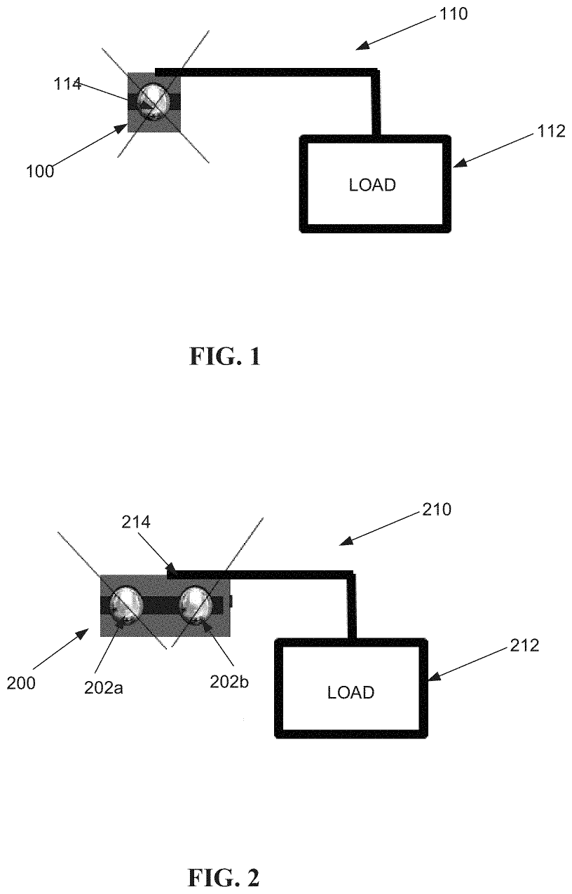

FIG. 1 illustrates a cross-section of a known bearing assembly 100 in a current gantry system 110. A gantry system 110 often must support a large mass or load 112. In current gantry systems 110, a ball bearing 114 is implemented to support the overhung load 112. The load 112 may result in the ball bearings 114 skidding or sliding rather than rolling. There is no practical means for balancing the load along the axis of the ball bearing 112 to eliminate this effect. The axial dimensions may not be modified to accommodate the required counterbalances using any practical methods. This skidding effect generates extra wear and tear on the ball bearings 114 and shortens the life expectancies of the bearing assembly 100.

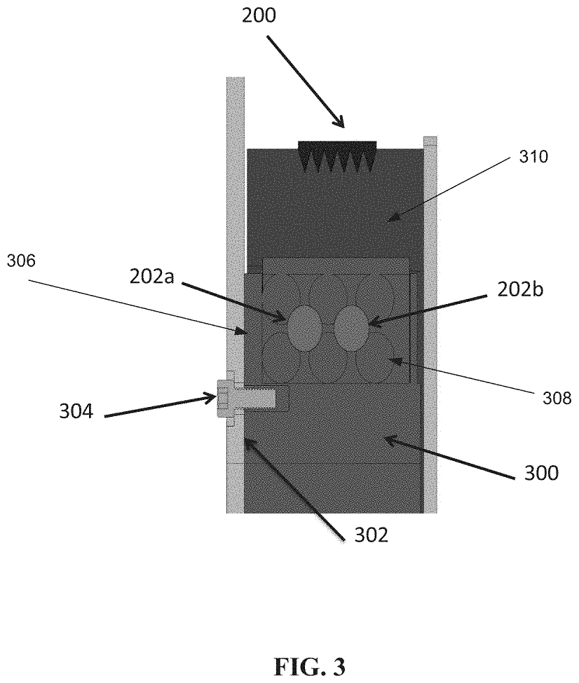

FIG. 2 illustrates a cross-section of an embodiment of a bearing assembly 200 in an improved gantry system 210. In this embodiment of the gantry system 210, two rows of ball bearings 202a, 202b are implemented. The large mass or load 212 is coupled to girders 214 of the ball bearing assembly along a central axis that runs between the two rows of ball bearings 202a, 202b. The load 212 then generates an approximately even force in a V pattern on the ball bearings 202a, 202b. This balanced load 212 improves the ability of the ball bearings 202 to roll and helps to prevent the ball bearings 202 from skidding or sliding.

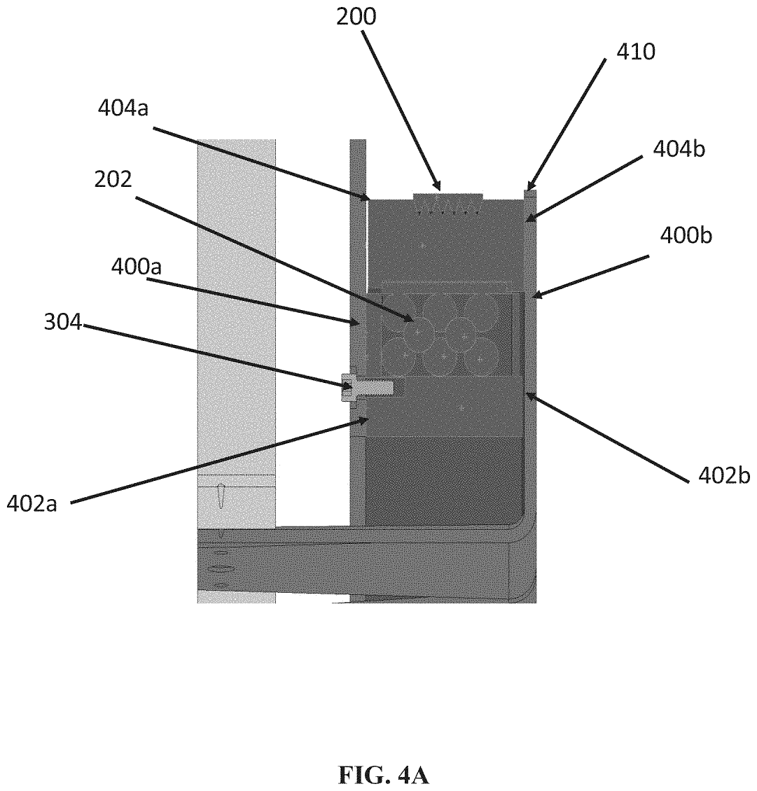

FIG. 3 illustrates a cross-section of another embodiment of the bearing assembly 200. The bearing assembly 200 includes an inner race portion 300 that includes the inner race and an inner peripheral surface of the bearing assembly 200. In this embodiment, the inner race portion 300 is fixed and does not move with the ball bearings 202a, 202b. The bearing assembly 200 further includes an outer race portion 310 that includes the outer race and an outer peripheral surface of the bearing assembly 200. The plurality of ball bearings 202 are disposed within a cage 308 between the inner race portion 300 and the outer race portion 310. The cage 308 retains the plurality of ball bearings 202 in two rows at regular intervals. The outer row portion 310 moves and rotates with the ball bearings 202.

An outer face 306 of the inner race portion 300 of the bearing assembly 200 is mounted to a mounting plate 302 using a screw 304 or other attachment mechanism. The aluminum plate 302 is fabricated from aluminum or an aluminum alloy. The aluminum alloy includes predominantly Al (e.g., greater than 50% aluminum (Al)), and one or more alloying substances, such as copper, magnesium, manganese, silicon, tin or zinc.

Heat being generated into bearings is an issue for the life expectancy of the bearing assembly 200. Ball bearings are preferably mounted in a fashion that promotes proper heat transfer away from the bearings. A better, less expensive material for this purpose is an aluminum plate for mounting. This aluminum plate promotes maintaining grease at a proper viscous level and prevents premature wear due to loss of lubricity. In another embodiment, the mounting plate 302 is predominantly steel rather than aluminum. The aluminum may bend more freely and need to be thicker than a steel mounting plate.

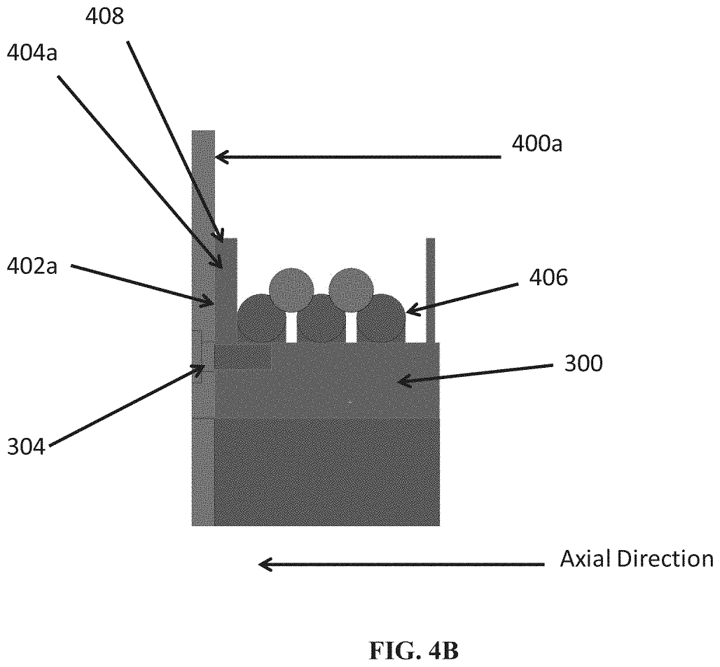

FIG. 4A illustrates a cross-section of an embodiment of a mounting system 410 for the bearing assembly 200. The inability to maintain consistent roundness of the ball bearings 202 and flatness of the outer faces 404a, 404b is an issue for bearing longevity. In general terms, not distorting a bearing assembly 200 is often quite difficult to achieve with normal machining and fabricating methods. The conflicts in roundness and flatness should yield to the natural geometry of the bearing assembly 200 instead of the surrounding components. This is assisted using two flat mounting surfaces to which the bearing assembly 200 is mounted.

In an embodiment, the mounting system 410 includes two parallel plates 400a, 400b, wherein each of the parallel plates 400a, 400b includes a bearing mounting face 402a, 402b. The bearing mounting face 402a, 402b of each parallel plate 400a, 400b is flat or approximately flat. The outer faces 404a, 404b of the bearing assembly 200 are coupled or attached respectively on the bearing mounting faces 402a, 402b between the parallel plates 400a, 400b. The flat surface of the bearing mounting faces 402a, 402b exerts a relatively uniform force on the outer faces 404a, 404b of the bearing assembly 200 to assist the outer faces 404a, 404b to remain relatively flat. Preferably, the bearing mounting faces 402a, 402b are flat over a substantial contact area (e.g. greater than 50%) of the flat surface of the outer faces 404a, 404b.

For example, the inner race portion 300 is fixed and attaches to a fixed mounting plate 400a. The outer face 404a of the inner race portion 300 is relatively flat and so the bearing mounting face 402a over a substantial portion of the flat surface of the inner race portion 300 is also relatively flat to conform or mold to the outer face 404a. The outer race portion 310 is in motion with the ball bearings 202 and attaches to a moving mounting plate 400b. The outer face 404b of the outer race portion 310 is relatively flat and so the bearing mounting face 402b over a substantial portion of the flat surface of the outer race portion 310 is also relatively flat to conform or mold to the outer face 404b.

FIG. 4B illustrates a cross-section of another embodiment of the mounting system 410 for the bearing assembly 200. The inner race portion 300 that includes the inner race of the bearing assembly 200 and an outer face 404a. A side portion 408 of the inner race portion 300 is adjacent to a cage 406 of the ball bearings 202 and sits between the inner race and the outer race. The mounting plate 400a includes a relatively flat bearer mounting face 402a.

In an embodiment, the mounting plate 400a has a thickness that is less than the thickness of the inner race portion 300. Preferably, the mounting plate 400a has a thickness that is less than the thickness of the side portion 408 of the inner race portion 300 as well. For example, a steel mounting plate 400a may be ¼ to ½ inch while an aluminum mounting plate 400a must be 1 inch thick. In contrast, the inner race portion 300 is at least 5 times as thick as the mounting plate 400a.

The thinner mounting plate 400a conforms to the outer face 404a of the bearing assembly 200. The mounting plate 400a is thus less likely to distort or deform the inner race portion 300 of the bearing assembly 200.

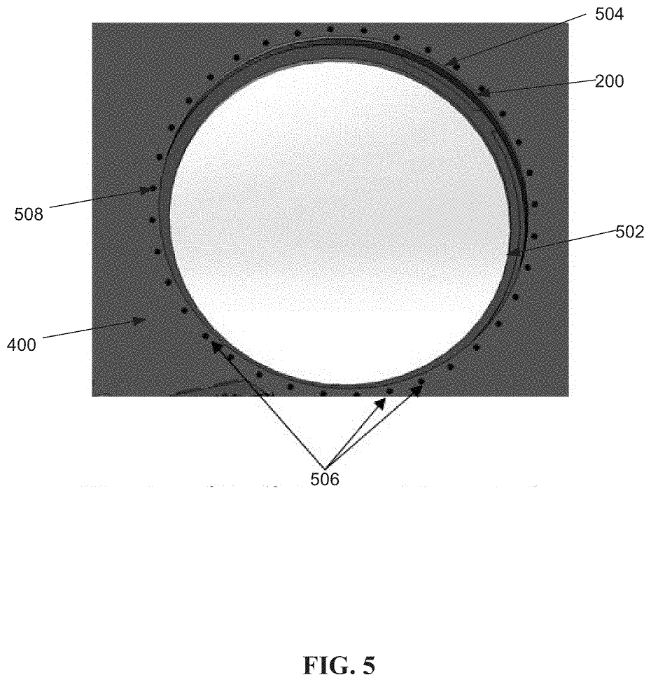

FIG. 5 illustrates a cross-section of another embodiment of the mounting system 410 in the gantry system 210. Since the mounting plates 400 can be fabricated relatively flat, the mounting of each mounting plate 400 in a sequence allows a stronger directions of the bearing to prevail when mounted in the configuration shown. The bearing assembly 200 bends each mounting plate 400 to the outer face 404 of the bearing assembly 200 instead of the mounting plates 400 deforming the outer faces 404. To facilitate this molding of the mounting plates 400 to the outer faces 404, selective weakening of the mounting plates 400 using radial slits may also be employed.

The bearing assembly 200 is manufactured within acceptable limits with respect to roundness of the inner race 502 and outer race 504 as well. Each mounting plate 400 is mounted to an outer face of the bearing assembly 200 using a bolt circle pattern 506. The bolts 508 are positioned along the circumference of the inner race 502 or outer race 504 of the bearing assembly 200 and helps prevent deformity of the roundness of the races in assembly as well.

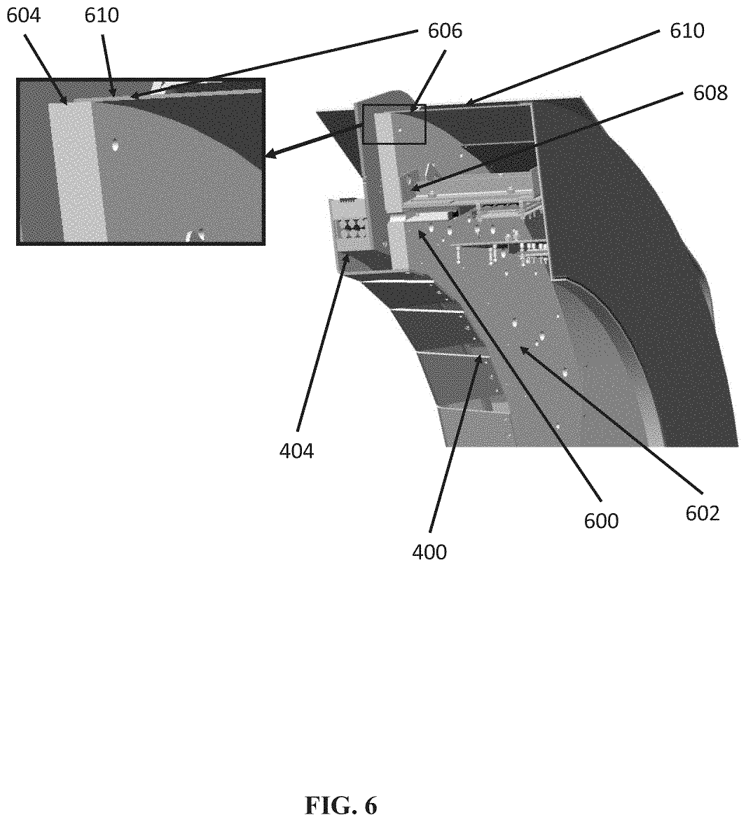

FIG. 6 illustrates a cross-section of another embodiment of the mounting system 410 in the gantry system 210. Distortion due to mounting of various apparatus can be an additive process that contributes to the uneven performance that so often occurs. Geometric solutions can be employed to correct this malady. For example, when more than three contact points are required to mount a load, then radial attachment 606 of the load, e.g. by a top bracket 610, to a top of the mounting plate 400 is preferred over affixing to the outer face 602 of the mounting plate 400. A load that is radially mounted cannot contribute to an out round condition nor can it cause a loss of flatness of the mounting plate 400.

A face mounted bracket 600 may include two or three contact points 608 that are attached to the outer face 602 of the mounting plate 400. This face mounting creates a planer relationship which will not distort flatness of the mounting plate 400. Thus, in an embodiment, multiple point mount attachments (e.g., a load requiring more than three contact points for attachment) are radially mounted to a top 604 of the mounting plate 400. A load requiring only two or three mount point brackets 600 may be mounted on an outer face 602 of the mounting plate 400.

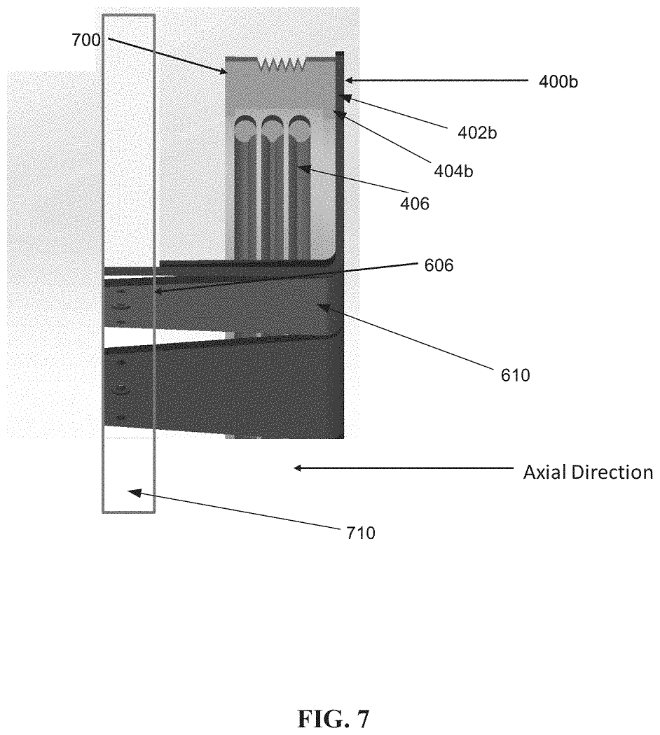

FIG. 7 illustrates a cross-section of another embodiment of the mounting system 410 in the gantry system 210. In this embodiment, the mounting plate 400b is attached to a rotating bearing section 700 (e.g., the outer race portion 310) that includes an outer race of the bearing assembly 200. The outer race is rotating due to the movement of the ball bearings 202 in the bearing cages 406. The mounting plate 400b includes a relatively flat bearer mounting face 402b.

In an embodiment, the mounting plate 400b has a thickness that is less than the thickness of the rotating bearing section 700. Preferably, the mounting plate 400b has a thickness that is less than the thickness of the rotating bearing section 700 as well. For example, a steel mounting plate 400b may be ¼ to ½ inch while an aluminum mounting plate 400b must be 1 inch thick. In contrast, the rotating bearing section 700 is at least 12 times as thick as the mounting plate 400b.

The relatively thin mounting plate 400b conforms to the outer face 404b of the rotating bearing section 700. The mounting plate 400b is thus less likely to distort or deform the rotating bearing section 700.

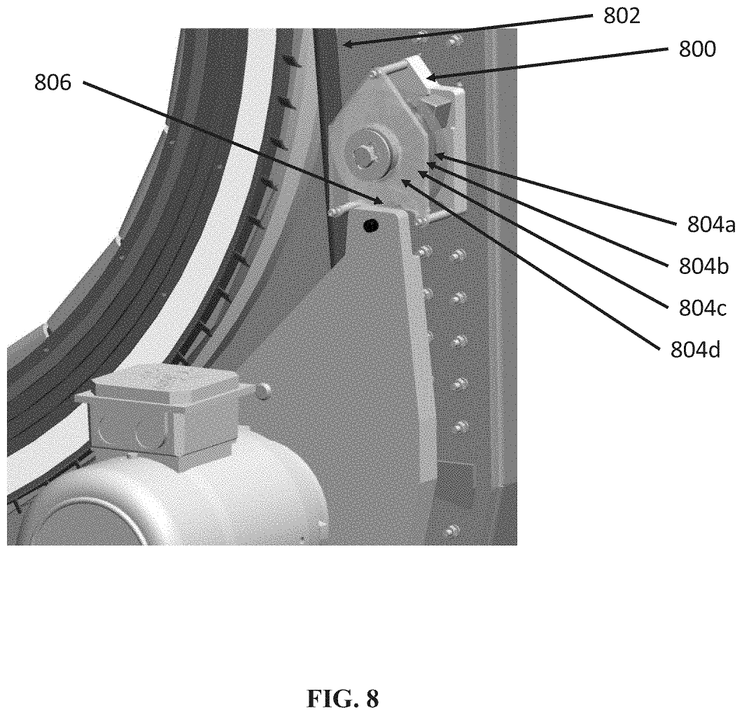

FIG. 8 illustrates a cross-section of a cross-sectional view of an embodiment of a tensioning system 800 in the gantry system 210. An improper tensioning of a belt 802 will result in failure. Back loading belts may cause premature failure as well. Since gaining access for belt tensioning is just as difficult as adding lubrication, an automatic tensioning system 800 is implemented in an embodiment of the gantry system 210. The automatic tensioning system 800 bends the belt 802 in the natural drive direction to avoid back-loading. The tensioning system 800 includes a spring-loaded assembly 806 to automatically adjust tension in the belt 802 in response to belt stretch or heat expansion. One or more springs 804a, 804b exert pressure on the assembly 806 to tension the belt 802. The springs 804a, 804b and assembly 806 are configured to apply a force perpendicular to a jerk force j of the belt 802. The jerk force may be represented as a vector derived from an acceleration of the tension belt 802 (e.g., a time derivative of the acceleration).

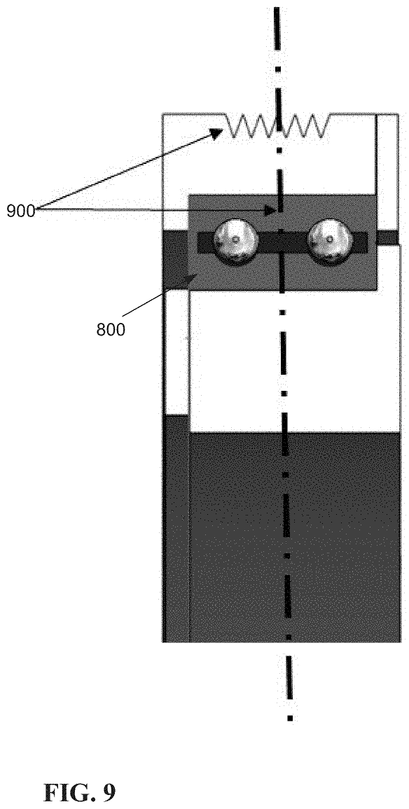

FIG. 9 illustrates a cross-section of another view of an embodiment of the tensioning system 800 in the gantry system 210. When drive belts are skewed from a center line of the bearing assembly 200, e.g. when driveline components are not aligned, gyroscopic forces are introduced into the system. These forces can be overcome by various stiffening structures but should not be created if possible. The center line of the pulley is thus preferably positioned approximately at or close to the center line of the bearing races in the bearing assembly 200.

The various embodiments described herein help to improve life expectancy of a gantry system. Various current problems addressed by the embodiments include for example: large overhung loads that are non-uniform and require balancing, heat being generated into bearings, inability maintain consistent roundness and flatness overall, distortion due to mounting of various apparatus, routine maintenance, proper tensioning of belt, and drive belts being skew of bearing center line. Any of the items can result in premature or even infant mortality of good components. By distorting flatness, a bearing can fail in very short amounts of time as if the load were to be doubled or tripled Likewise, a bearing running dry can cause cascading types of failures that result in most of the life expectancy to be eliminated in the last 5% of its total life. It is the same with belts. Often, maintenance can go wrong when unexpected changes (loose screws etc.) have been made that result in other failures. Various embodiments described herein address the overall performance criteria to improve life to expected levels by helping to eliminate the current problems.

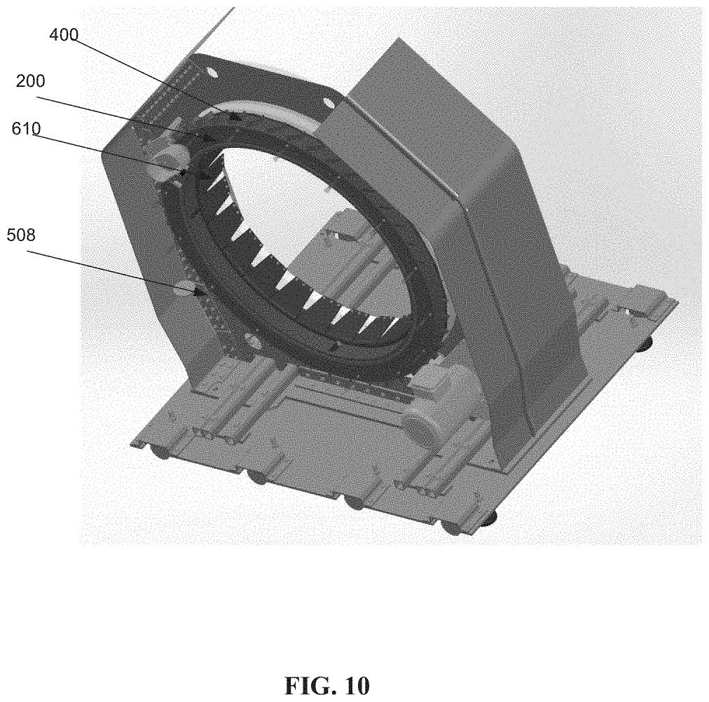

FIG. 10 illustrates a perspective view of an embodiment of the gantry system 210 implemented in a computed tomography (CT) scanner. The bearing assembly 200 is mounted to the mounting plate 400 by the plurality of bolts 508 using a bolt circle pattern 506. A radial attachment 606 of a load, e.g. by a top bracket 610, to a top of the mounting plate 400 is shown.

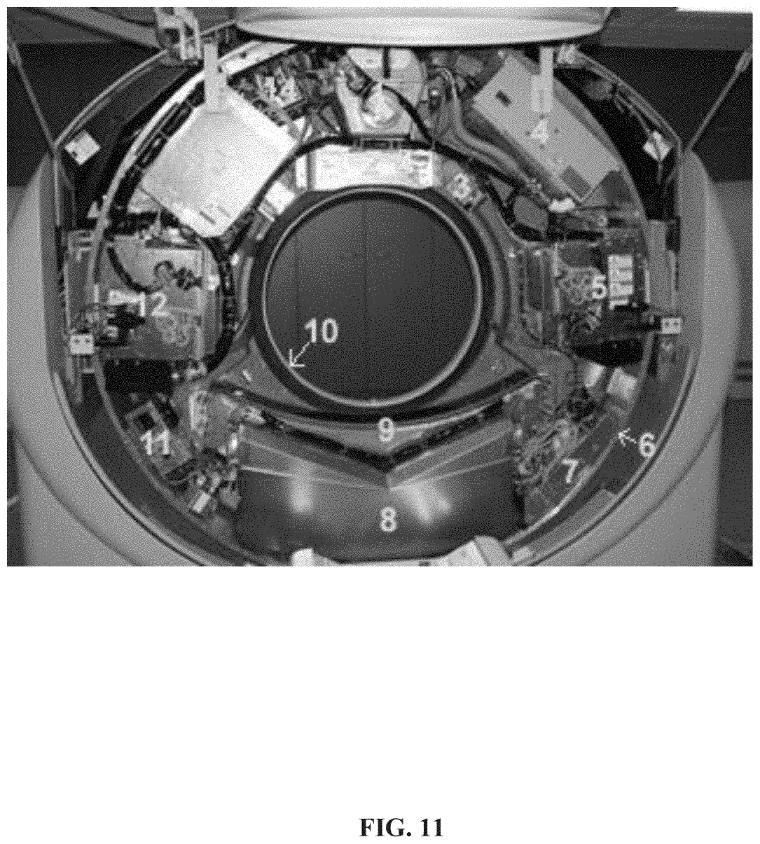

FIG. 11 illustrates an internal view of an embodiment of a gantry system 210 of a CT scanner. The gantry system 210 described herein may be included in an image scanning system to support a radiation detector and/or a radiation source. The CT scanner includes a direct drive gantry motor 5, rotation control unit 6 and the bearing assembly 10. In addition, the CT scanner includes an x-ray tube 1, a detector 2, an internal projector 3 and x-ray tube heat exchanger 4, high voltage generator 4, data acquisition system (DAS) 8, detectors 9, detector temperature controller 11, high voltage generator 12, power unit 13 and line noise filter 14.

The gantry system 210 may also be implemented in other type of systems, such as a gantry crane or other applications. The gantry system may include one or more of the embodiments described herein.

As may be used herein, the term “operable to” or “configurable to” indicates that an element includes one or more of components, attachments, circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled”, “coupled to”, “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, network element, etc.). As may further be used herein, inferred connections (i.e., where one element is connected to another element by inference) includes direct and indirect connection between two items in the same manner as “connected to”. As may be used herein, the terms “substantially” and “approximately” provides an industry-accepted tolerance for its corresponding term and/or relativity between items.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

In the foregoing specification, certain representative aspects of the invention have been described with reference to specific examples. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

1. A gantry system, comprising:
a bearing assembly including:
at least two rows of ball bearings; and
an inner race portion including an inner race and a first outer peripheral face, wherein the first outer peripheral face is relatively flat; and
an outer race portion including an outer race and a second outer peripheral face, wherein the second outer peripheral face is relatively flat; and
a first mounting plate mounted to the first outer peripheral face of the inner race portion, wherein a substantial portion of the first mounting plate is relatively flat where it contacts the first outer peripheral face; and
a second mounting plate mounted to the second outer peripheral face of the outer race portion, wherein a substantial portion of the second mounting plate is relatively flat where it contacts the second outer peripheral face.

2. The gantry system of claim 1, wherein the first mounting plate is face mounted to the first outer peripheral face of the inner race portion with a plurality of bolts positioned in an approximately circular pattern around a circumference of the inner race portion.

3. The gantry system of claim 1, wherein the first mounting plate has a thickness less than a thickness of the inner race portion.

4. The gantry system of claim 1, wherein the second mounting plate has a thickness less than a thickness of the outer race portion.

5. The gantry system of claim 1, wherein the first and second mounting plate are aluminum or an aluminum alloy.

6. The gantry system of claim 1, further comprising:
a radially mounted bracket attached to a top of the second mounting plate, wherein the radially mounted bracket is attached to a load requiring three or more contact points for attachment.

7. The gantry system of claim 6, further comprising:
a face mounted bracket attached to a peripheral face of the second mounting plate, wherein the face mounted bracket is attached to a load requiring three or less contact points for attachment.

8. The gantry system of claim 1, further comprising:
a tension belt; and
a tensioning system configured to automatically adjust a tension of the tension belt.

9. The gantry system of claim 8, wherein the tensioning system includes a spring assembly configured to apply a force perpendicular to a jerk vector derived from an acceleration of the tension belt.

10. A gantry system, comprising:
a bearing assembly including:
at least two rows of ball bearings; and
an inner race portion that is fixed including an inner race and a first outer peripheral face, wherein the first outer peripheral face is relatively flat; and
an outer race portion that moves radially along an axis with the two rows of ball bearings including an outer race and a second outer peripheral face, wherein the second outer peripheral face is relatively flat; and
a first mounting plate that is fixed and mounted to the first outer peripheral face of the inner race portion, wherein a substantial portion of the first mounting plate is relatively flat where it contacts the first outer peripheral face.

11. The gantry system of claim 10, further comprising:
a second mounting plate that moves with the outer race portion and is mounted to the second outer peripheral face of the outer race portion, wherein a substantial portion of the second mounting plate is relatively flat where it contacts the second outer peripheral face.

12. The gantry system of claim 10, wherein the first mounting plate is face mounted to the first outer peripheral face of the inner race portion with a plurality of bolts positioned in an approximately circular pattern around a circumference of the inner race portion.

13. The gantry system of claim 10, wherein the first mounting plate has a thickness less than a thickness of the inner race portion.

14. The gantry system of claim 10, wherein the second mounting plate has a thickness less than a thickness of the outer race portion.

15. The gantry system of claim 10, wherein the first and second mounting plate are aluminum or an aluminum alloy.

16. The gantry system of claim 10, further comprising:
a radially mounted bracket attached to a top of the second mounting plate, wherein the radially mounted bracket is attached to a load requiring three or more contact points for attachment.

17. The gantry system of claim 16, further comprising:
a face mounted bracket attached to a peripheral face of the second mounting plate, wherein the face mounted bracket is attached to a load requiring three or less contact points for attachment.

18. The gantry system of claim 10, further comprising:
a tension belt; and
a tensioning system configured to automatically adjust a tension of the tension belt.

19. The gantry system of claim 18, wherein the tensioning system includes a spring assembly configured to apply a force perpendicular to a jerk vector derived from an acceleration of the tension belt.
